(19) United States
(12) Patent Application Publication
(10) Pub. No.: US 2024/0423770 A1
(43) Pub. Date: Dec. 26, 2024

(54) ELECTRIC TOOTHBRUSH

(71) Applicant: GUANGZHOU STARS PULSE CO.,LTD., GUANGZHOU (CN)

(72) Inventors: KUNGUANG LIU, GUANGZHOU (CN); ZHUOYING LI, GUANGZHOU (CN); LIANGYU WU, GUANGZHOU (CN); ZIHAO LIN, GUANGZHOU (CN); HUIXIANG HUANG, GUANGZHOU (CN)

(21) Appl. No.: 18/824,190

(22) Filed: Sep. 4, 2024

(30) Foreign Application Priority Data
Mar. 11, 2023 (CN) 202322991119.7
Dec. 15, 2023 (CN) 202323443034.1

(51) Int. Cl. A61C 17/22; A46B 5/00; A46B 13/02; A46B 15/00; A46D 3/00

(52) U.S. Cl. CPC A61C 17/225; A46B 5/00; A46B 13/02; A46B 15/0036; A46D 3/00

(57) ABSTRACT

An electric toothbrush includes a handle housing and a driving component. The handle housing includes a main shell and an interactive shell. The main shell and the interactive shell are connected to each other. The interactive shell is integrally formed. The interactive shell includes a viewing shell and a button portion. The driving component is disposed in the handle housing. The driving component includes a detection piece and a display light source. The detection piece is disposed corresponding to the button portion to detect whether the button portion is pressed or touched. The display light source is disposed corresponding to the viewing shell to transmit light to an outside of the handle housing. A processing technology of the handle housing of the electric toothbrush is simple and there are fewer surface gaps on the electric toothbrush.

### TECHNICAL FIELD

The present disclosure relates to a technical field of oral cleaning, and in particular to an electric toothbrush.

### BACKGROUND

In order to enable an electric toothbrush to have a good interaction effect, a handle thereof generally includes a light-transmitting cover corresponding to a display piece thereof, so as to transmit light emitted by the display piece through the light-transmitting cover. In addition, the handle further includes a button for controlling a motor to operate or controlling a mode/level switching of the electric toothbrush.

However, in the brush handle of the related art, the button and the light-transmitting cover are generally independent pieces. Specifically, the button and the light-transmitting cover need to be respectively mounted on the brush handle, or the button is mounted on the light-transmitting cover, and then the light-transmitting cover with the button is mounted on the brush handle, making a manufacturing process complex.

### SUMMARY

Embodiments of the present disclosure provide an electric toothbrush, in which a viewing shell and a button portion are integrally formed to simplify manufacturing steps of the handle housing and define less surface gaps on the handle housing compared with a conventional electric toothbrush.

Embodiments of the present disclosure provide the electric toothbrush. The electric toothbrush includes a handle housing and a driving component. The handle housing includes a main shell and an interactive shell. The main shell and the interactive shell are connected to each other. The interactive shell includes a viewing shell and a button portion. The driving component is disposed in the handle housing. The driving component includes a detection piece and a display light source. The detection piece is disposed corresponding to the button portion to detect whether the button portion is pressed or touched. The display light source is disposed corresponding to the viewing shell to transmit light to an outside of the handle housing through the viewing shell.

In the electric toothbrush of the embodiments of the present disclosure, since the interactive shell is an integrally formed piece, in an actual manufacturing process, the interactive shell, including the viewing shell and the button portion that are made of same material, is formed by one-time molding. Then the interactive shell is connected to the main shell, for example, the interactive shell and the main shell are subjected to secondary injection molding, so that manufacture of the handle housing including the viewing shell and the button portion is realized in two steps. Compared with a conventional electric toothbrush in the related art, in which a viewing shell and a button portion thereof are first manufactured separately, and then the button portion and the viewing shell are respectively connected to the main shell in three steps, the handle housing of the present disclosure has simpler steps in terms of process manufacturing.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a structural schematic diagram of an electric toothbrush according to one embodiment of the present disclosure.

FIG. 2 is an exploded schematic diagram of the electric toothbrush shown in FIG. 1.

FIG. 3 is a schematic diagram of a handle housing connected to a driving component of the electric toothbrush shown in FIG. 1.

FIG. 4 is a cross-sectional schematic diagram of the electric toothbrush taken along the line A-A shown in FIG. 3.

FIG. 5 is an enlarged schematic diagram of area B shown in FIG. 4.

FIG. 6 is an exploded schematic diagram of the handle housing and the driving component shown in FIG. 3.

FIG. 7 is another schematic diagram of the handle housing connected to the driving component of the electric toothbrush shown in FIG. 1.

FIG. 8 is another schematic diagram of the handle housing connected to the driving component of the electric toothbrush shown in FIG. 1.

FIG. 9 is another schematic diagram of the handle housing connected to the driving component of the electric toothbrush shown in FIG. 1.

FIG. 10 is a schematic diagram of an interactive shell of the handle housing shown in FIG. 9.

FIG. 11 is a cross-sectional schematic diagram of the interactive shell taken along the line C-C shown in FIG. 10.

FIG. 12 is another schematic diagram of the interactive shell of the handle housing shown in FIG. 9.

FIG. 13 is a schematic diagram of the handle housing connected to the driving component where the interactive shell is removed.

FIG. 14 is an enlarged schematic diagram of area D shown in FIG. 13.

FIG. 15 is an exploded schematic diagram of the handle housing and the driving component where the interactive shell is removed.

FIG. 16 is a structural schematic diagram of the electric toothbrush according to another embodiment of the present disclosure.

FIG. 17 is an exploded schematic diagram of the electric toothbrush shown in FIG. 16.

FIG. 18 is an enlarged schematic diagram of area A shown in FIG. 17.

FIG. 19 is a partial exploded schematic diagram of the handle housing of the electric toothbrush shown in FIG. 16.

FIG. 20 is a structural schematic diagram of the interactive shell of the electric toothbrush shown in FIG. 16.

### DETAILED DESCRIPTION

In order to make the purpose, technical solutions, and advantages of the present disclosure clear, the following further describes the present disclosure in detail with reference to accompanying drawings and embodiments.

When the following description refers to the drawings, the same numbers in different drawings refer to the same or similar pieces unless otherwise indicated. The implementations described in the following exemplary embodiments do not represent all implementations consistent with the present disclosure. Rather, they are merely examples of apparatus and methods consistent with certain aspects of the present disclosure, as detailed in the appended claims.

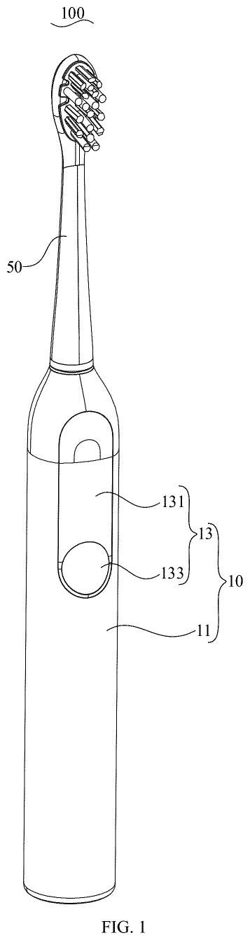

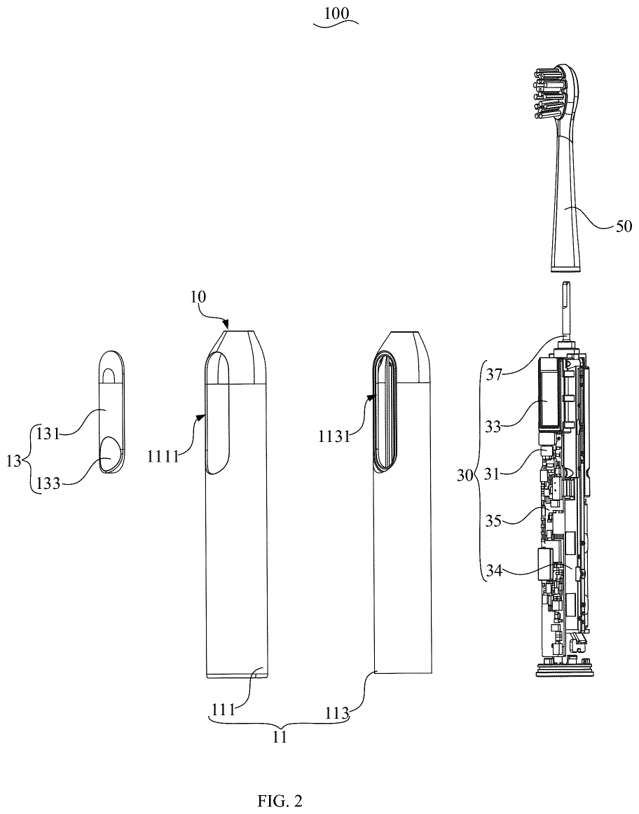

As shown in FIGS. 1 and 2, the present disclosure provide an electric toothbrush. The electric toothbrush includes a handle housing 10, a driving component 30, and a brush head 50. The driving component 30 is disposed in an interior of the handle housing 10. The brushed head 50 is connected to the driving component 30 and is driven by the driving component 30.

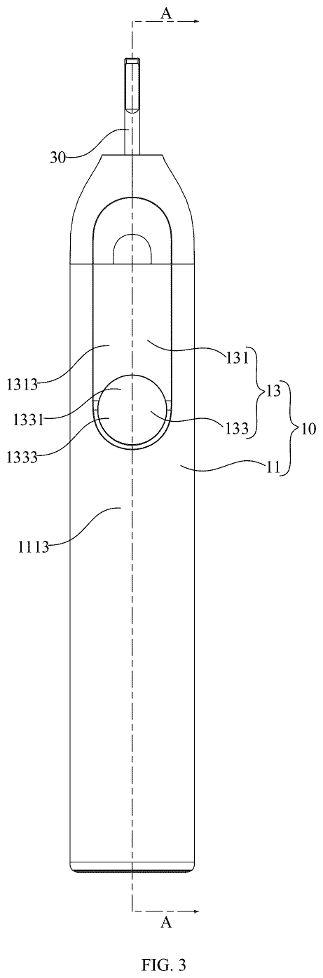

As shown in FIGS. 2-3, the handle housing 10 is a cylindrical structure. The handle housing 10 is an artistic piece of the electric toothbrush 100 and is configured to be held by a user to facilitate the user to use the electric toothbrush 100. Moreover, the handle housing 10 protects the driving component 30 disposed in the handle housing 10.

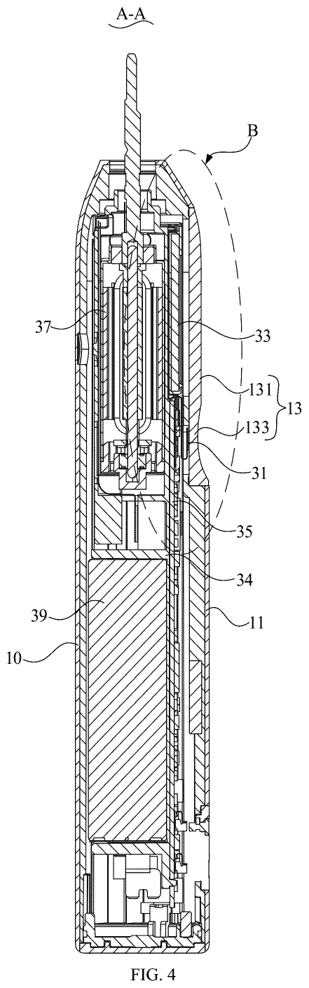

As shown in FIG. 4, the driving component 30 is served as a power piece to realize a brushing function of the electric toothbrush 100. The driving component 30 includes a bracket 34, a circuit board 35, a battery 39, and a motor 37, etc. The bracket 34 is configured to support the circuit board 35, the battery 39, the motor 37, etc. The battery 39 is configured to supply power to the motor 37 and the circuit board 35. The circuit board 35 is configured to control an operation of the motor 37. An output shaft of the motor 37 is connected to the brush head 50 to drive the brush head 50. In actual use, when the motor 37 works, high-frequency vibration energy of the motor 37 is transmitted to the brush head 50 through the output shaft, so that when the brush head 50 is placed in an oral cavity of the user, the brush head 50 is capable of cleaning the oral cavity of the user.

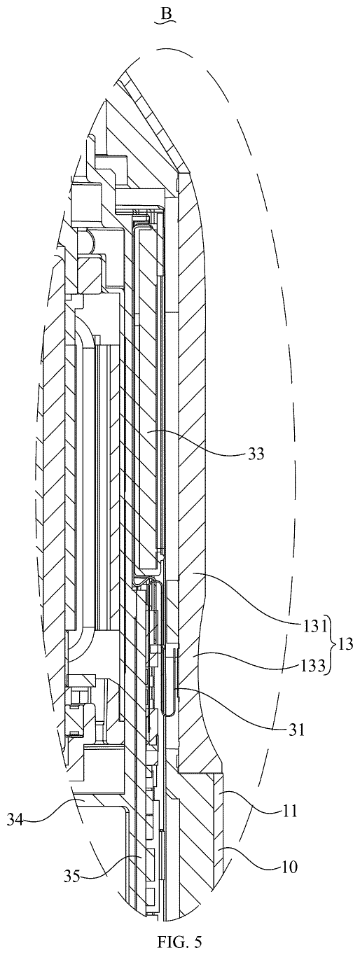

As shown in FIGS. 4-5, in some embodiments, the electric toothbrush 100 has a display function, which provides prompts or guidance during a brushing process of the user. Therefore, the driving component 30 includes a display light source 33. The display light source 33 may include at least one display screen or at least one lamp bead. The display light source 33 is electrically connected to the circuit board 35. Under control of the circuit board 35, the display light source 33 emits light when working, and the light is transmitted outside the handle housing 10 and noticed by the user, thereby realizing the display function of the electric toothbrush 100. In addition, the electric toothbrush 100 further has a control function, and the user is able to control start and stop of the motor 37 or an operating frequency of the motor 37 during the brushing process. Accordingly, the driving component 30 includes a detection piece 31, and the detection piece 31 is a contact detection piece or a non-contact detection piece. The detection piece 31 is electrically connected to the circuit board 35. A detection signal of the detection piece 31 is sent to the circuit board 35, and the circuit board 35 controls the motor 37 according to the detection signal to realize the start and stop of the motor 37 or a change of the operating frequency, thereby realizing the control function of the electric toothbrush 100.

As shown in FIGS. 4-5, in order to make the handle housing 10 light-transmissive and enable the user to control the detection piece 31, the handle housing 10 includes a main shell 11 and an interactive shell 13. The main shell 11 and the interactive shell 13 are connected to each other, and an interaction between the user and the electric toothbrush 100 is realized through the interactive shell 13.

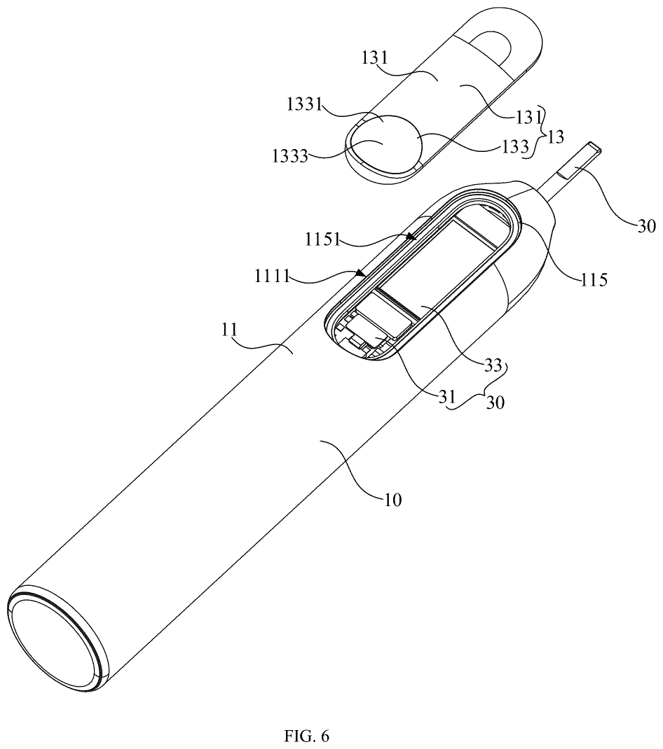

As shown in FIGS. 5-6, specifically, the interactive shell 13 includes a viewing shell 131 and a button portion 133. The display light source 33 is disposed corresponding to the viewing shell 131 so that the display light source 33 is allowed to transmit the light to the outside of the handle housing 10 through the viewing shell 131. In this way, the light emitted by the display light source 33 is transmitted through the viewing shell 131 to realize the display function of the electric toothbrush 100. The detection piece 31 is disposed corresponding to the button portion 133 so that the detection piece 31 is able to detect whether the button portion 133 is pressed or touched to realize the control function of the electric toothbrush 100. For example, when the detection piece 31 is in a form of the contact detection piece, the user is able to press the button portion 133 to make the button portion 133 contact the detection piece 31 and trigger the control function of the electric toothbrush 100. Alternatively, when the detection piece 31 is in a form of the non-contact detection piece, the user is able to touch the button portion 133, and the detection piece 31 is controller to detect specific parameters on the button portion 133, then the detection piece 31 detects that the button portion 133 is touched by the user and triggers the control function of the electric toothbrush 100.

In some embodiments, when the detection piece 31 is in the form of the contact detection piece, the detection piece 31 includes a pressure switch or a button. When the detection piece 31 is a pressure switch, the button portion 133 is configured to deform and press the pressure switch, so that the pressure switch is triggered by pressing the button portion 133. It is understood that the pressure switch has a fast response speed, which improves fluency of the user in a controlling process of the motor 37 by pressing the button portion 133. Further, the pressure switch has a high reliability and ensures long-term and relatively stable operation. When the detection piece 31 is the button, the button portion 133 is configured to trigger the button by deforming and abutting against the button. It is understood that there is a clear sense of abutment during a triggering process of the button portion 133 deforming and abutting the button, which provides a clear operational feedback to the user and enhances a user experience. Moreover, the button has high mechanical reliability and stability, which ensures long-term and relatively stable operation. In addition, cost of the button is low, which effectively reduces manufacturing cost of the electric toothbrush 100.

In other embodiments, when the detection piece 31 is in the form of the non-contact detection piece, the detection piece 31 is a light detection piece, a sound wave detection piece, or a temperature detection piece. When the detection piece 31 is the light detection piece, the button portion 133 is light-transmissive. When the user touches the button portion 133, the hand of the user blocks light transmitted to the button portion 133. The light detection piece is configured to detect a luminous flux at the button portion 133, so the light detection piece is able to detect whether the user touches the button portion 133 by detecting a change of the luminous flux.

When the detection piece 31 is a sound wave detection piece, and when the hand of the user is placed at the position of the button portion 133, a sound wave signal emitted by the sound wave detection piece is reflected, so that the sound wave detection piece is able to detect whether the user touches the button portion 133 by detecting the sound wave signal reflected at the button portion 133.

When the detection piece 31 is a temperature detection piece, and when the hand of the user touches the button portion 133, heat exchange occurs between the button portion 133 and the hand, causing a temperature on the button portion 133 to change, so that the temperature detection piece is able to detect whether the user touches the button portion 133 by detecting a temperature signal on the button portion 133.

On the basis that the detection piece is the non-contact detection piece, the detection piece 31 is able to detect whether the button portion 133 is touched by the user without physically contacting the button portion 133. Therefore, by arrangement of the detection piece 31, the button portion 133 is allowed to be fixed relative to the viewing shell 131 or the main shell 11, so that the interactive shell 13 is capable of being made into a rigid integrated component, and the electric toothbrush 100 has a higher structural strength and a lower possibility of mildewing.

Following embodiments take an instance that the detection piece 31 is the contact detection piece for further illustration. Specifically, the button portion 133 abuts or presses the detection piece 31 to trigger the detection piece 31, which makes a manufacturing process of the handle housing 10 of the electric toothbrush 100 of the present disclosure simple, and effectively improves production efficiency of the electric toothbrush 100 in a workshop.

Furthermore, as shown in FIG. 5-6, the interactive shell 13 is an integrally formed component. For example, the interactive shell 13 is made from plastic material or plastic material, and in an actual manufacturing process, the interactive shell 13 including the viewing shell 131 and the button portion 133 is formed at one time by injection molding. The viewing shell 131 and the button portion 133 are made from a same material. Based on this, on the basis of the electric toothbrush 100 having the interactive functions such as the display function and the control function, the electric toothbrush 100 further has following technical effects.

Since the interactive shell 13 is an integrally formed piece, in an actual manufacturing process, the interactive shell 13, including the viewing shell 131 and the button portion 133 that are made of the same material, is formed by one-time molding. Then the interactive shell 13 is connected to the main shell 11, for example, the interactive shell 13 and the main shell 11 are subjected to secondary injection molding, so that a stable connection between the main shell 11 and the handle housing 10 is realized in two steps. Compared with a conventional electric toothbrush in the prior art, in which a viewing shell and a button portion thereof are first manufactured separately, and then the button portion and the viewing shell are respectively connected to the main shell in three steps, the handle housing 10 pf the present disclosure has simpler steps in terms of process manufacturing, which facilitates productions of the interactive shell 13 and the main shell 11, which greatly improves the production efficiency of the workshop.

In addition, the interactive shell 13 is integrally formed, which not only increases an overall strength of the interactive shell 13, ensures an overall integrity of the interactive shell 13, and makes the interactive shell 13 not easily deformed or damaged when subjected to an external force, but also makes side walls of the viewing shell 131 and side walls of the button portion 133 gaplessly connected, thereby solving a problem that when there are gaps between the side walls of the viewing shell and the side walls of the button portion to harbor dirt and bacteria.

In some embodiments, the main shell 11 and the interactive shell 13 are integrally formed, so that the main shell 11 is gaplessly connected to the interactive shell 13.

As shown in FIG. 6, in some embodiments, the interactive shell 13 and the main shell 11 are split pieces, and the interactive shell 13 is connected to the main shell 11 by at least one connection method selected from bonding, clamping, and interference fit. In this way, after the interactive shell 13 and the main shell 11 are separately molded, the interactive shell 13 is connected to the main shell 11, so that the interactive shell 13 and the main shell 11 are flexibly manufactured respectively.

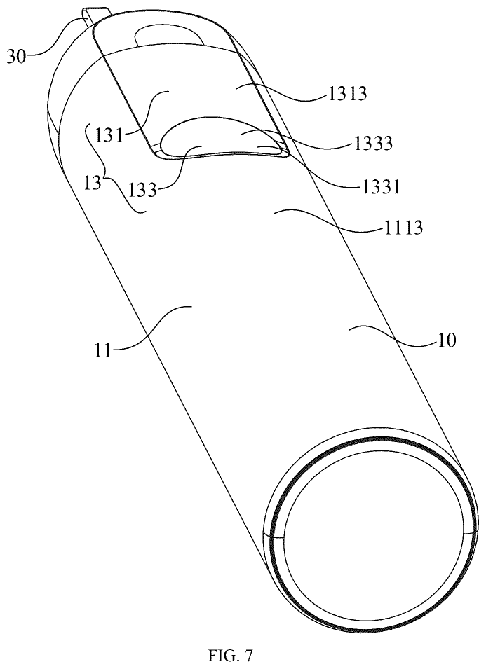

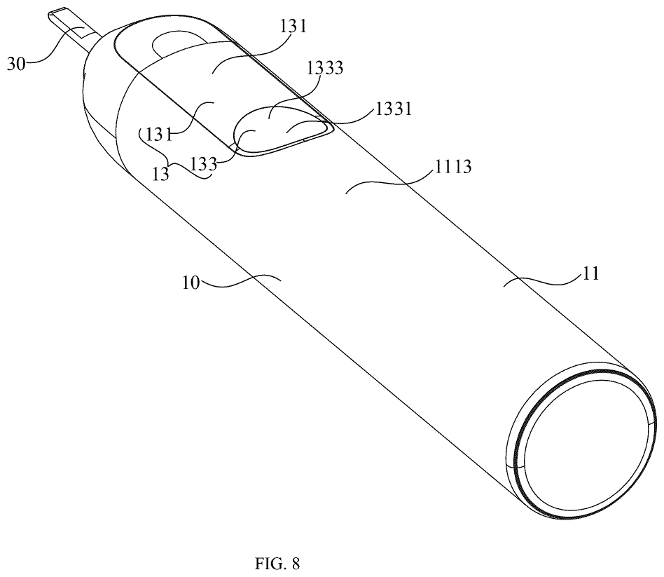

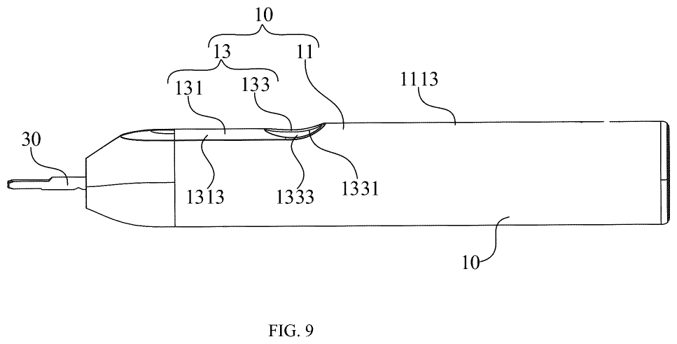

As shown in FIGS. 7-9, in other embodiments, the interactive shell 13 and the main shell 11 are integrally formed, so that the interactive shell 13 and the main shell 11 are gaplessly connected. For example, the interactive shell 13 is a plastic piece or a plastic piece, which is molded as a whole with the main shell 11 through an injection molding process to be gaplessly connected to the main shell 11. Therefore, existences of gaps between the interactive shell 13 and the main shell 11 are avoided, and leakage or dirt in the gaps are avoided.

As shown in FIGS. 7-9, in some embodiments, an outer surface 1313 of the viewing shell 131 is an arc surface protruding in a direction away from the display light source 33 relative to an outer surface of the button portion 133. Thus, compared to an example that the outer surface 1313 of the viewing shell 131 being in a form of an arc surface recessed relative to the outer surface 1333 of the button portion 133 in the direction close to the display light source 33, or compared to an example that the outer surface 1313 of the viewing shell 131 being in a form of a flat surface, a form of the outer surface 1313 of the viewing shell 131 of the embodiments of the present disclosure increases an observation angle. That is, the observation angle of the viewing shell 131 is made larger, so that the user is able to observe the outer surface 1313 of the viewing shell 131 at different holding angles, thereby improving the user experience. Optionally, the outer surface 1313 of the viewing shell 131 may be the flat surface or the arc surface recessed in the direction close to the display light source 33, and the embodiments of the present disclosure is not limited thereto.

Furthermore, as shown in FIGS. 7-9, the outer surface 1313 of the viewing shell 131 defines a first curvature. The main shell 11 includes a front surface 1113 on a same side as the interactive shell 13. The front surface 1113 of the main shell 11 defines a second curvature. The first curvature is less than the second curvature. In this way, the outer surface 1313 of the viewing shell 131 is less curved and smoother than the front surface 1113 of the main shell 11, so that the light is less refracted and scattered when penetrating through the outer surface 1313 of the viewing shell 131, which effectively reduces a deformation degree of the light and improves a display effect of the display light source 33. In addition, when the first curvature is less than the second curvature, a height of the outer surface 1313 of the viewing shell 131 is lower than a height of the front surface 1113 in a radial direction of the handle housing 10 and in a direction away from the interior of the handle housing 10, so that when the electric toothbrush 100 accidentally falls, the main shell 11 has a high probability of colliding with ground first, thereby reducing a probability of the outer surface 1313 of the viewing shell 131 colliding with the ground, prolonging the service life of the interactive shell 13, and reducing a risk of scratches on the viewing shell 131 of the interactive shell 13. In other embodiments, the first curvature may be equal to the second curvature, so that overall appearance consistency between the outer surface 1313 of the viewing shell 131 and the front surface 1113 is better, or the first curvature is greater than the second curvature, which is not limited in the embodiments of the present disclosure.

As shown in FIGS. 7-9, in some embodiments, the interactive shell 13 is a hard light-transmitting plastic piece, The main shell 11 defines a mounting opening 1111 for mounting the interactive shell 13, and an outer peripheral wall of the interactive shell 13 is connected to tan inner wall of the mounting opening 1111 to cover the mounting opening 1111. In this way, on the basis of the interactive shell 13 being the hard light-transmitting plastic piece, the interactive shell 13 has better strength itself, so as to be suitable for a scene where the user repeatedly presses the button portion 133 of the interactive shell 13. Since the interactive shell 13 has better strength itself, the interactive shell 13 is not easy to deform when subjected to force, which reduce a possibility of cracking of the interactive shell 13. Further, the viewing shell 131 of the interactive shell 13 is not easy to be scratched, so the viewing shell 131 maintains a good display effect under long-term use.

As shown in FIGS. 7-9, in some embodiments, the button portion 133 has a first thickness H1 in the radial direction of the handle housing 10, and the viewing shell 131 has a second thickness H2 in the radial direction of the handle housing 10.

The first thickness H1 is greater than the second thickness H2. It is understood that in actual use, the user needs to press the button portion 133 to realize the control function of the electric toothbrush 100, so a force application position of the hand of the user on the interactive shell 13 mainly falls on the position of the button portion 133. Based on this, by setting the first thickness H1 to be greater than the second thickness H2, a structural strength of the button portion 133 is better, so as to be suitable for a scene where the button portion 133 needs to be repeatedly pressed by the user. In other embodiments, the first thickness H1 is not greater than the second thickness H2, and the embodiments of the present application are not limited thereto.

Furthermore, as shown in FIGS. 6-11, an outer surface 1333 of the button portion 133 defines a pressing area 1331. The pressing area 1331 is an arc surface recessed toward the detection piece 31 relative to the outer surface 1331 of the viewing shell 131. In this way, when the user presses the button portion 133, the pressing area 1331 provides the user with a unique touch feeling and provides the user with a positioning prompt, which effectively improves an operation accuracy of the button portion 133 by the user when not looking at the button portion 133. Moreover, on the basis of setting the pressing area 1331 as a recessed arc surface, when the outer surface 1313 of the viewing shell 131 is the arc surface protruding relative to the outer surface 1333 of the button portion 133 in the direction away from the display light source 33, the pressing area 1331 forms a contrast with the outer surface 1313 of the viewing shell 131. Furthermore, the pressing area 1331 adapts to a surface of a finger, so that the user is able to distinguish the pressing area 1331 from the viewing shell 131 by a difference in touch feeling, reducing a probability that the user hardly find the pressing area 1331 and press the viewing shell 131 when operating blindly. In addition, in terms of external aesthetics, the pressing area 1331 is the arc surface recessed toward the detection piece 31 relative to the outer surface 1313 of the viewing shell 131, so that the button portion 133 is not obtrusive in appearance compared to the main shell 11, thereby improving overall aesthetics of the handle housing 10. In other embodiments, the pressing area 1331 may be an arc surface protruding relative to the outer surface 1313 of the viewing shell 131 in the direction away from the detection piece 31, or the pressing area 1331 may be a flat surface, and the present disclosure is not limited thereto.

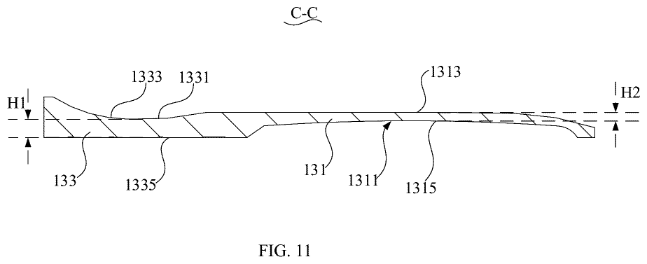

As shown in FIGS. 6 and 11, in some embodiments, in the radial direction of the handle housing 10 facing the interior of the handle housing 10, a height of an inner surface 1335 of the button portion 133 is greater than a height of an inner surface 1315 of the viewing shell 131. The inner surface 1335 of the button portion 133 is a flat surface facing the detection piece 31 or an arc surface protruding towards the detection piece 31. It is understandable that in the embodiments of the present disclosure, a distance between the inner surface 1335 of the button portion 133 and the detection piece 31 is shortened, so that a pressing stroke between the button portion 133 and the detection piece 31 is shortened, reducing operating force required by the user when pressing the button portion 133, which not only improves sensitivity of triggering the detection piece 31 when pressing, but also enables the user to complete an operation of pressing the button portion 133 to press or abut against the detection piece 31 more quickly, thereby effectively improving the user' experience. In other embodiments, in the radial direction of the handle housing 10 facing the interior of the handle housing 10, the height of the inner surface 1335 of the button portion 133 is less than the height of the inner surface 1315 of the viewing shell 131, or in the radial direction of the handle housing 10 facing the interior of the handle housing 10, the height of the inner surface 1335 of the button portion 133 is equal to the height of the inner surface 1315 of the viewing shell 131, and the embodiments of the present application are not limited thereto.

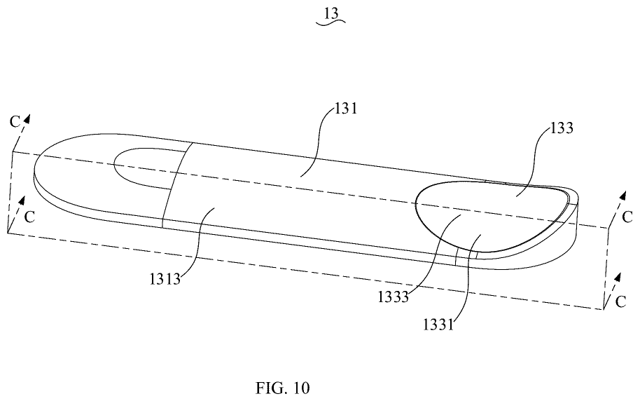

As shown in FIGS. 6 and 11, in some embodiments, the inner surface 1315 of the viewing shell 131 includes an inner light-transmitting area 1311 disposed opposite to the display light source 33 (as shown in FIG. 10). The inner light-transmitting area 1311 is an arc surface recessed in the direction away from the display light source 33 relative to the inner surface 1335 of the button portion 133. In this way, an overall thickness of the viewing shell 131 is reduced, so that the light emitted by the display light source 33 is less refracted and scattered when penetrating through the viewing shell 131, thereby improving a final display effect of the light.

Furthermore, the outer surface 1313 of the viewing shell 131 is an arc surface recessed relative to the outer surface 1333 of the button portion 133 in the direction away from the display light source 33. In this way, the outer surface 1313 of the viewing shell 131 and the inner surface of the viewing shell 131 are arc surfaces that are protruded outward, which make the viewing shell 131 have a relatively uniform thickness, enable a certain structural strength of the viewing shell 131, and avoid a large degree of refraction of the light transmitted to the viewing shell 131, thereby improving the final display effect of the light. In other embodiments, the inner light-transmitting area 1311 is a flat surface or an arc surface protruding in the direction toward the display light source 33 relative to the inner surface 1335 of the button portion 133, and the present disclosure is not limited thereto.

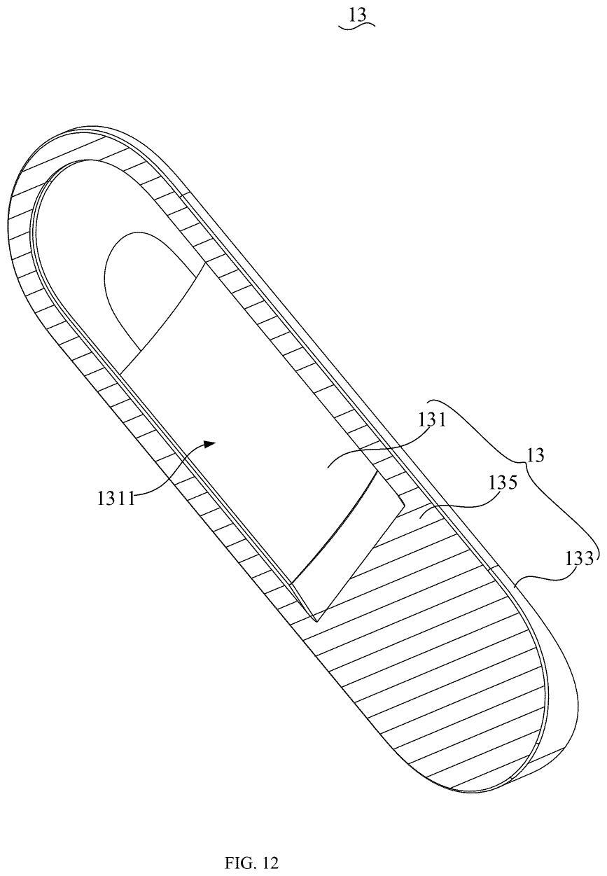

As shown in FIG. 12, in some embodiments, the interactive shell 13 further includes a light-shielding layer 135. The light-shielding layer 135 covers a surface of the interactive shell 13 and does not cover the viewing shell 131. In this way, a light emitting range of the light emitted by the display light source 33 is limited by the light-shielding layer 135. The viewing shell 131 is disposed corresponding to the display light source 33, so that the light emitted by the display light source 33 is transmitted to the outside of the handle housing 10 through the viewing shell 131.

Specifically, the light-shielding layer 135 is light-shielding paint, light shielding ink or light shielding cloth, etc., which is not limited thereto. For instance, the light-shielding layer 135 is disposed on an inner surface of the interactive shell 13 and does not cover the inner light-transmitting area 1311. Compared with the light-shielding layer 135 being disposed on an outer surface of the interactive shell 13, the light-shielding layer 135 is prevented from peeling off due to friction.

In the actual manufacturing process, the interactive shell 33 including the viewing shell and the button portion 133 is integrally formed in the workshop. Then, on the basis that the interactive shell 13 is the integrally formed piece, the light-shielding layer 135 is disposed on the inner surface or the outer surface of the interactive shell 13 and does not cover the inner light-transmitting area 1311. At the same time, on the basis that the inner surface 1315 of the viewing shell 131 includes the inner light-transmitting area 1311, and the inner light-transmitting area 1311 is the arc surface recessed relative to the inner surface 1335 of the button portion 133 in the direction away from the display light source 33, the inner light-transmitting area 1311 plays a restriction role and prevent the light-shielding layer 135 from being coated to the viewing shell 131.

As shown in FIGS. 10-11, in some embodiments, the pressing area 1331 is the arc surface that is recessed toward the detection piece 31 relative to the outer surface 1313 of the viewing shell 131. The outer surface 1313 of the viewing shell 131 is the arc surface protruding relative to the pressing area 1331 in the direction away from the display light source 33. The outer surface 1313 of the viewing shell 131 and the pressing area 1331 are smoothly transited. In this way, the pressing area 1331 provides a unique touch feel for the user when the user presses the button portion 133, and while providing the user the positioning prompt, the viewing shell 131 has a large viewing angle for the user to observe. On this basis, by setting the outer surface 1313 of the viewing shell 131 and the pressing area 1331 to be smoothly transited, the interactive shell 13 is prevented from being uncomfortable to the hand. Further, since there is no step structure between the button area and the outer surface 1313 of the viewing shell 131, the user's sight of observing the viewing shell 131 of the interactive shell 13 is not blocked.

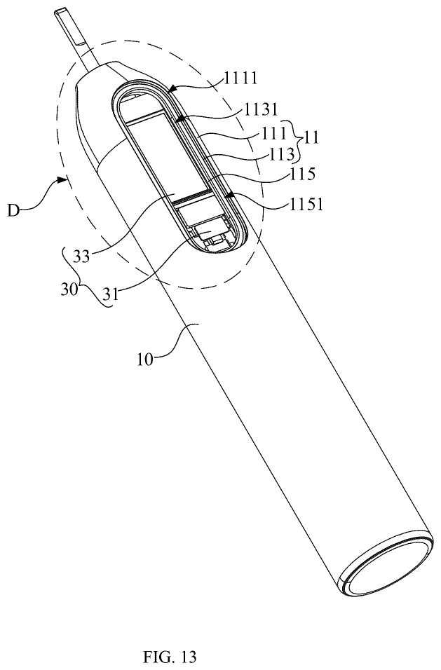

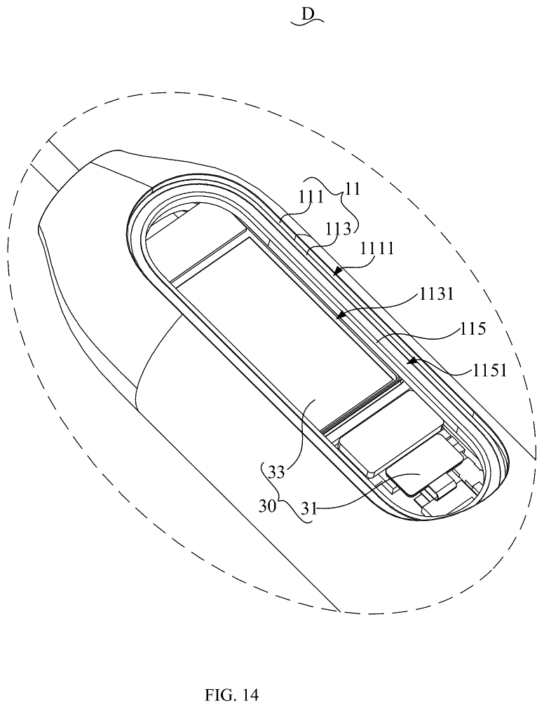

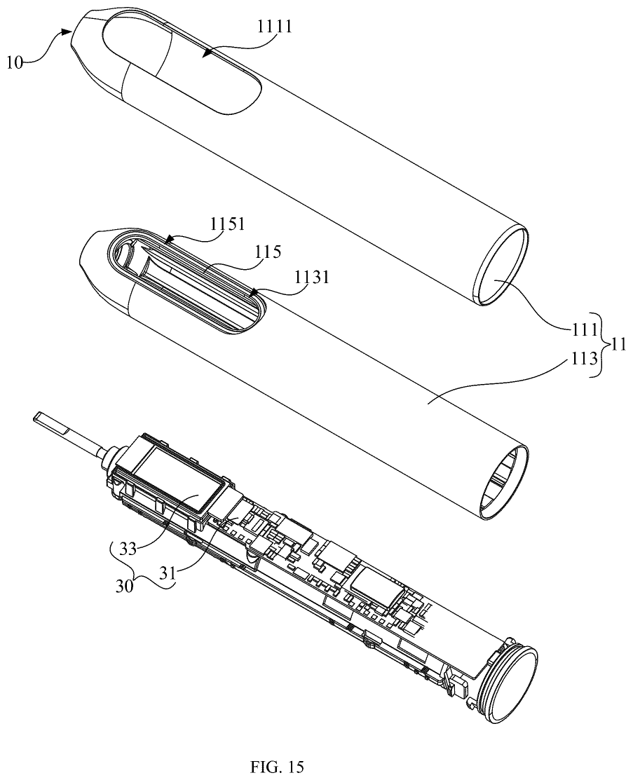

As shown in FIGS. 13-15, in some embodiments, the main shell 11 includes a metal shell 111 and a plastic shell 113. The metal shell 111 defines a mounting opening 1111. The interactive shell 13 is mounted in the mounting opening 1111 to cover the mounting opening 1111. The plastic shell 113 is disposed on an inner wall of the metal shell 111. The driving component 30 is connected to the plastic shell 113. The plastic shell 113 defines a through hole 1131 communicated with the mounting opening 1111. The button portion 133 is matched with the detection piece 31 through the through hole 1131. The light emitted by the display light source 33 transmits out through the through hole 1131 and the viewing shell 131 in sequence.

It is understood that the metal shell 111 is made of aluminum or stainless steel, etc., and the plastic shell 113 is a plastic piece. The plastic shell 113 is connected to the inner wall of the metal shell 111 through the injection molding process or a dispensing assembly process. The plastic shell 113 includes a connecting structure. The plastic shell cooperates with the bracket 34 of the driving component 30 through the connecting structure. For example, the connecting structure may be a snap-on structure, a limiting structure, a guiding structure, or a fixing structure. The plastic shell 113 is the plastic piece, which is convenient for molding the connecting structure through the injection molding process, and the plastic shell 113 is connected to the bracket 34 of the driving component 30 through the connecting structure, so as to achieve fixed mounting of the bracket 34 of the driving component 30 in the handle housing 10.

Relatively speaking, if the connecting structure is disposed on the inner wall of the metal shell 111, the connecting structure may be very difficult to process. Common metal processing processes include a forging process, a die casting process, a compression casting process, etc. A core of the forging process is forging, which is unable to process the connecting structure, and although the die casting process and the compression casting process are enabled to form the connecting structure, they are unable to accurately form the connecting structure at a specific position on the inner wall of the metal shell 111, resulting in the connecting structure being unable to align with the driving component 30.

As shown in FIGS. 13-15, in some embodiments, an aperture of the through hole 1131 is less than an aperture of the mounting opening 1111 to define a support platform 115 on a bottom portion of the through hole 1131. The support platform 115 is annular and is configured to support the interactive shell 13. That is, a step structure is formed between the plastic shell 113 and the metal shell 111. A step surface of the step structure forms the support platform 115. The interactive shell 13 is carried by the support platform 115, so that the interactive shell 13 is not recessed into the handle housing 10. Especially when the interactive shell 13 includes the button portion 133, the support platform 115 solves a problem that button portion 133 is easily sunken inward due to frequently pressing by the user.

It should be supplemented that when the interactive shell 13 is the hard light-transmitting plastic piece, due to the good strength of the interactive shell 13 itself, a supporting structure for supporting the interactive shell 13 is selectively disposed in the interior of the handle housing 10, For example, the support platform 115 is selectively not provided, so that an overall structure of the handle housing 10 is simplified.

As shown in FIGS. 13-15, in some embodiments, a surface of the support platform 115 supporting the interactive shell 13 defines an adhesive filling groove 1151. The adhesive filling groove 1151 is n annular. Adhesive (not shown in the drawings) is disposed in the adhesive filling groove; 1151 and the adhesive is bonded with an edge area of an inner surface of the interactive shell 13.

It is understood that the surface of the support platform 115 configured to support the interactive shell 13 is an annular surface to support the interactive shell 13 in an annular direction. In addition, the support platform 115 is bonded to the inner surface of the interactive shell 13 in the annular direction of the support platform 115 through the adhesive disposed in the adhesive filling groove 1151, so as to further improve supporting stability of the support platform 115 on the interactive shell 13. For example, the button portion 133 of the interactive shell 13 is located in a middle area of the interactive shell 13 rather than the edge area, which improves the supporting stability of the support platform 115 on the interactive shell 13. Further, when the adhesive is bonded to the edge area of the inner surface of the interactive shell 13, the adhesive does not interfere too much with a deformation action of the button portion 133 when the button portion 133 is pressed.

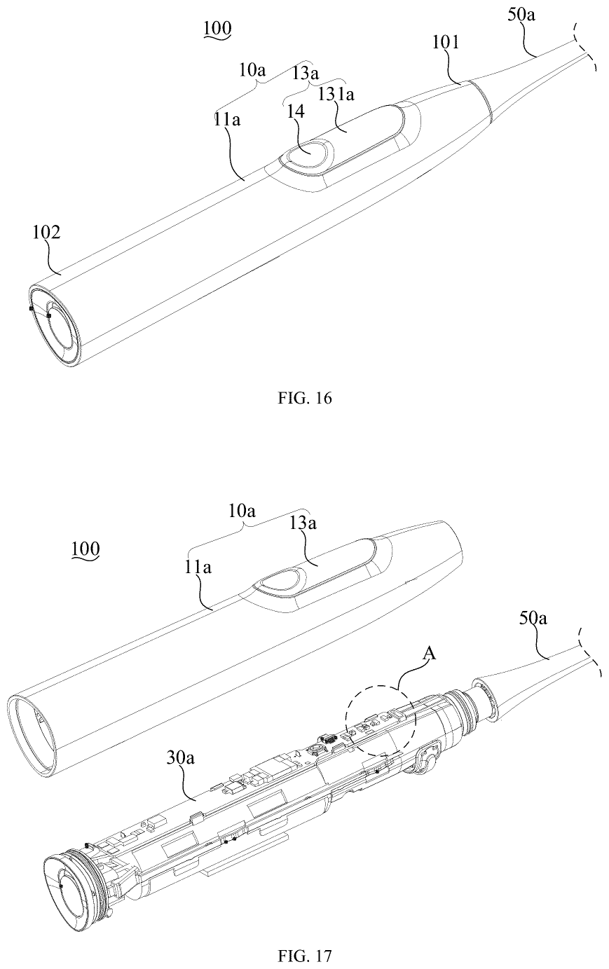

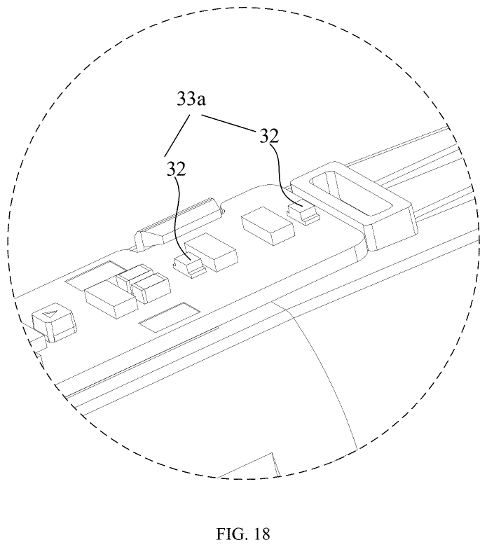

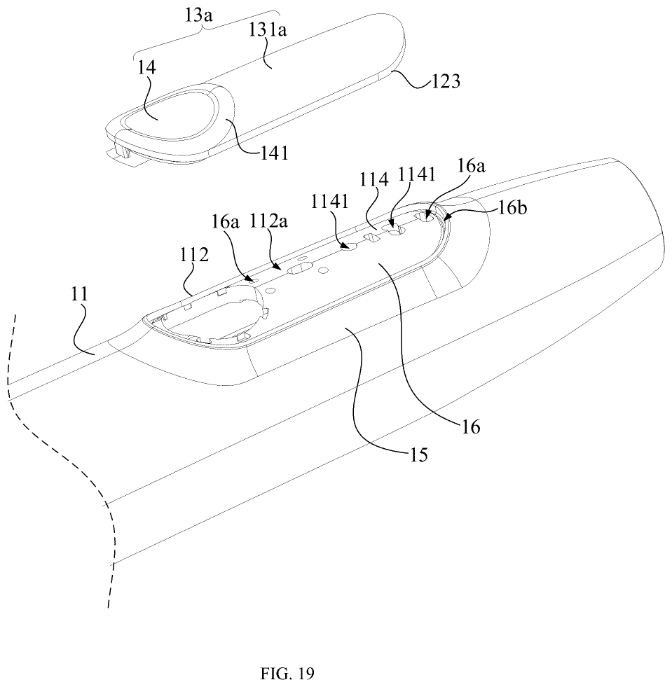

As shown in FIGS. 16-17, another embodiment of the present disclosure provides an electric toothbrush 100a. The electric toothbrush 100a includes a handle housing 10a, a driving component 30a disposed in the handle housing 10a, and a brush head 50a driven by the driving component 30a. Structures of the driving component 30a and the brush head 50a are similar to structures of the driving component 30 and the brush head 50 in the aforementioned embodiments, and are not described in detail herein. A structure of the handle housing 10a that is different from the handle housing 10 in the aforementioned embodiments is described in detail as follow.

In some embodiments, the handle housing 10a includes a main shell 11a and an interactive shell 13a mounted on the main shell 11a.

The main shell 11a includes a mounting piece 112. A light-transmitting portion 114 is disposed in the mounting piece 112. The light-transmitting portion 114 is disposed corresponding to the display light source 33a. Light emitted by the display light source 33a (e.g. the lamp beads 32) passes through the light-transmitting portion 114 to transmit out of the handle housing 10.

The interactive shell 13a is disposed on an outer surface of the mounting piece 112 and is fixedly connected to the main shell 11a. That is, the interactive shell 13a is exposed from the main shell 11a and is relatively fixed on the main shell 11a. The interactive shell 13a at least includes a viewing shell 131a that is light-transmitting, and the viewing shell 131a is disposed corresponding to the light-transmitting portion 114, so that the light emitted by the display light source 33a in the handle housing 10a is able to pass through the light-transmitting portion 114 and the viewing shell 131a to the outside of the handle housing 10a, thereby realizing the display function of the electric toothbrush 100a.

Furthermore, the interactive shell 13a is made from soft rubber. Since the interactive shell 13a includes the viewing shell 131a, the viewing shell 131a is also made from the soft rubber. In this way, the viewing shell 131a is elastically deformable relative to the main shell 11a. Therefore, on the basis of the viewing shell 131a having a light-transmitting function, it also has following technical effects.

When the electric toothbrush 100a accidentally falls, the main shell 11a and the viewing shell 131a may collide with the ground. If the main shell 11a collides with the ground, the main shell 11a is deformed due to an impact force of the ground, causing the main shell 11a to compress or pull the interactive shell 13a. When the interactive shell 13a collides with the ground, the interactive shell 13a is also subjected to the impact force. Since the interactive shell 13a is made from the soft rubber, when the interactive shell 13a is compressed or pulled by the main shell 11a, or when the interactive shell 13a is directly subjected to the impact force of the ground, the interactive shell 13a elastically deformed and consume the impact force. Therefore, differ from the hard light-transmitting shell in the related art, the interactive shell 13a does not crack or separate from the main shell 11a due to force, thereby improving service life of the viewing shell 131a and stability of the viewing shell 131a on the main shell 11a.

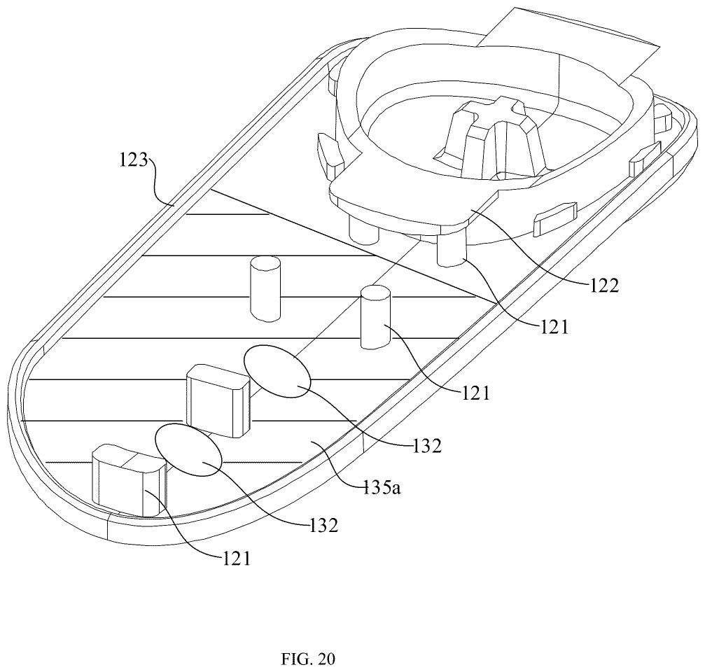

As shown in FIG. 20, in some embodiments, a light-shielding layer 135a (an oblique-lined shading area in FIG. 20) is disposed on a surface of the viewing shell 131a. The viewing shell defines light-emitting areas 132 not covered by the light-shielding layer. The light-emitting areas 132 are disposed corresponding to the light-transmitting portion 114. That is, the light-shielding layer 135a limits a scope of the light-emitting areas 132, and the light-emitting areas 132 are disposed corresponding to the light-transmitting portion 114, so that the light emitted by the display light source 33a passes through the light-transmitting portion 114 of the main shell 11a and the light-emitting areas 132 of the viewing shell 131a in sequence and pass out of the handle housing 10a.

Specifically, the light-shielding layer 135a is light-shielding paint, light-shielding ink, or light-shielding cloth, etc., which is not limited thereto. For example, the light-shielding layer 135a is disposed on an inner surface of the viewing shell 131a. Compared with disposing the light-shielding layer 135a on an outer surface of the viewing shell 131a, the light-shielding layer 135a is prevented from falling off due to friction, and the light from the light-emitting areas 132 is prevented from passes out from the light-shielding layer 135a.

As shown in FIGS. 19-20, in some embodiments, the main shell 11a and the mounting piece 112 are non-light-transmitting pieces, so the main shell 11a and the mounting piece 112 are integrally injection molded. In this way, a manufacturing process of the main shell 11a and the mounting piece 112 is simplified, production cost is reduced, and connection stability between the mounting piece 112 and the main shell 11a is enhanced. The light-transmitting portion 114 includes light-transmitting holes 1141 penetrating through the mounting piece 112. The light-transmitting holes 1141 are disposed corresponding to the display light source 33a and the viewing shell 131a. In this way, the light emitted by the display light source 33a is transmitted through the light-transmitting holes 1141, thereby realizing a display function of the electric toothbrush 100a.

Furthermore, the interactive shell 13a is molded on the mounting piece 112 through the injection molding process, thereby strengthening tightness of the connection between the interactive shell 13a and the mounting piece 112. In the process of injection molding the interactive shell 13a, the viewing shell 131a is partially filled in the light-transmitting holes 1141, so that a connection area between the interactive shell 13a and the mounting piece 112 is increased, connection stability between the interactive shell 13a and the mounting piece 112 is enhanced, and a risk of the interactive shell 13a falling off from the mounting piece 112 is reduced. At least portions of the viewing shell 131a filled in the light-transmitting holes 1141 are light-transmitting, so that the light emitted by the display light source passes through the light-transmitting holes 1141 and the viewing shell 131a to realize the display function of the electric toothbrush 100a.

As shown in FIGS. 19-20, in some embodiments, the light-transmitting portion 114 includes the light-transmitting holes 1141 corresponding to the viewing shell 131a, and the light-transmitting holes 1141 are disposed at intervals along an axial direction of the handle housing 10a. The light-transmitting holes 1141 are disposed one-to-one corresponding to the lamp beads 32 of the display light source 33a of the electric toothbrush 100a. The lamp beads of the display light source 33a are disposed at intervals along the axial direction of the handle housing 10a, and the light-transmitting holes 1141 are disposed one-to-one corresponding to the lamp beads 32 along the axial direction of the handle housing 10a. The light-transmitting holes 1141 are also disposed corresponding to the viewing shell 131a. Specifically, the light-transmitting holes 1141 are disposed one-to-one with the light-emitting areas 1141 on the viewing shell 131a. In this way, the light emitted by each of the lamp beads 32 passes through a corresponding light-transmitting hole 1141 and is emitted through a corresponding light-emitting area 132, which expands a display range of the lamp beads 32 in the axial direction of the handle housing 10a, making it easier for users to observe displayed information. Alternatively, different lamp beads are displayed in different colors or flashing frequencies according to actual needs to provide different prompt information to the user.

It is understood that the display light source 33a is one or more display screens disposed corresponding to the light-transmitting holes 1141. For example, display screens are disposed one-to-one corresponding to the light-transmitting holes 1141. Alternatively, multiple display areas are defined on one display screen, and the display areas are disposed one-to-one corresponding to the light-transmitting holes 1141.

In some embodiments, the main shell 11a is a non-light-transmitting piece, and the mounting piece 112 is a light-transmitting piece. The mounting piece 112 as a whole is served as the light-transmitting portion 114, so that the light emitted by the display light source 33a passes through the mounting piece 112 and the viewing shell 131a to realize the display function. Since the main shell 11a and the mounting piece 112 are made from different materials, the main shell 11a and the mounting piece 112 are manufactured and formed by different processes. That is, the main shell 11a and the mounting piece 112 are split components, so that flexibility of the main shell 11a and the mounting piece 112 in the manufacturing process is improved.

In some embodiments, the main shell 11a and the mounting piece 112 are integrally formed and are light-transmitting pieces, so that the manufacturing process of the main shell 11a and the mounting piece 112 is simplified, the production cost is reduced, and the connection stability between the mounting piece 112 and the main shell 11a is enhanced. The light-shielding layer 135a is disposed on the surface of the main shell 11a, so that the light emitted by the display light source 33a is prevented from being emitted through the main shell 11a, and light leakage is avoided. Therefore, the light emitted by the display light source 33a is concentratedly emitted from the mounting piece 112 and the viewing shell 131a, thereby improving brightness of the viewing shell 131a, avoiding light waste, and avoiding waste of electric energy.

As shown in FIG. 19, in some embodiments, the mounting piece 112 defines a mounting groove 112a recessed relative to a surface of the main shell 11a, and the interactive shell 13a is mounted in the mounting groove. The interactive shell 13a is mounted in the mounting groove 112a, which increases a contact area between the interactive shell 13a and the main shell 11a, improves connection stability between the interactive shell 13a and the main shell 11a, and helps to reduce a protruding height of the interactive shell 13a relative to the main shell 11a to avoid rubbing the hand.

In some embodiments, the interactive shell 13a is integrally formed with the main shell 11a. For example, the handle housing 10a is made from plastic material. The main shell 11a is first molded by the injection molding process, and then the interactive shell 13a is molded on the main shell 11a by secondary injection molding, two-color injection molding, or lamination. In this way, not only the connection stability between the interactive shell 13a and the main shell 11a is increased, but also a peripheral side wall of the interactive shell 13a and a groove wall of the mounting groove 112a being gaplessly connected, thereby fundamentally solving a problem that a gap between the peripheral side wall of the interactive shell 13a and the groove wall of the mounting groove 112a may hide dirt or harbor bacteria.

As shown in FIG. 19, in some embodiments, the mounting piece 112 includes a protruding portion 15. The protruding portion 15 is annular. The protruding portion 15 protrudes relative to a surface of the main shell 11, and the mounting groove 112a is defined in the protruding portion 15. In this way, after the interactive shell 13a is mounted in the mounting groove 112a, the viewing shell 131a is protruded relative to the surface of the main shell 11 as needed, so that the user more easily observes the light transmitted by the viewing shell 131a. In addition, since the protruding portion 15 is protruded relative to the main shell 11, a depth of the mounting groove 112a is increased accordingly, and the interactive shell 13a is embedded deeper in the mounting groove 112a, which improves the stability of the interactive shell 13a in the mounting groove 112a.

As shown in FIG. 19, in some embodiments, the mounting piece 112 includes a support portion 16 configured as a groove bottom of the mounting groove 112a. The support portion 16 supports the interactive shell 13a. A hardness of the support portion 16 is greater than a hardness of the interactive shell 13a. For example, the support portion 16 is made from the same material as the main shell 11a. In this way, when the interactive shell 13a is subjected to a large external force, the support portion 16 supports the interactive shell 13a to prevent the interactive shell 13a from being damaged due to excessive deformation or from being separated from the main shell 11a.

In other embodiments, the mounting groove 112a may not be defined in the mounting piece 112. At this time, the mounting piece 112 still includes the support portion 16 configured to support the interactive shell 13a, and the support portion 16 prevents the interactive shell 13a from being damaged due to excessive deformation or from being separated from the main shell 11a.

On the basis that the main shell includes the support portion 16, the light-transmitting portion 114 includes the light-transmitting holes 1141 defined on the support portion 16. The light-transmitting holes 1141 are disposed corresponding to the viewing shell 131a and are disposed corresponding to the display light source of the electric toothbrush 100a. The light emitted by the display light source 33a passes through the light-transmitting holes 1141 and passes out through the viewing shell 131a. In other embodiments, the light-transmitting portion 114 may be a light-transmitting structure disposed on the support portion 16, such as a light-transmitting plastic, a light-transmitting glass, etc.

As shown in FIGS. 19-20, in some embodiments, positioning columns 121 are disposed on one of an inner surface of the interactive shell 13a and the support portion 16. Positioning holes 16a are defined on the other one of the inner surface of the interactive shell 13a and the support portion 16. For example, as shown in FIG. 19, the positioning columns 121 are disposed on the inner surface of the interactive shell 13a, and as shown in FIG. 20, the positioning holes 16a are defined on the support portion 16. Alternatively, the positioning holes 16a are defined on the inner side of the interactive shell 13a, and the positioning columns 121 are disposed on the support portion 16. Alternatively, the positioning columns 121 and the positioning hole 16a are disposed on both the inner side of the interactive shell 13a and the support portion 16. The positioning columns 121 respectively pass through the positioning holes 16a. In this way, when the interactive shell 13a and the main shell 11a are formed separately, positioning and mounting between the interactive shell 13a and the main shell 11a is realized. Regardless of whether the interactive shell 13a and the main shell 11a are integrally formed or separately formed, a contact area between the interactive shell 13a and the support portion 16 is increased, thereby improving the stability of the interactive shell 13a on the main shell 11a.

As shown in FIGS. 19-20, in one specific embodiment, the positioning columns 121 are disposed on the inner surface of the interactive shell 13a, and the positioning holes 16a are defined on the support portion 16. The positioning columns 121 respectively pass through the positioning holes 16a. Furthermore, as shown in FIG. 20, the interactive shell 13a further includes stop portion 122. The stop portion 122 is connected to ends of the positioning columns 121 passing through the positioning holes 16a. The stop portion 121 and the inner surface of the interactive shell 13a jointly clamp the support portion 16.

That is, the support portion 16 is disposed between the inner surface of the interactive shell 12 and the stop portion 122, the positioning columns 121 pass through the support portion 16, and two ends of each of the positioning columns 121 are connected to the stop portion 122 and the inner surface of the interactive shell 13a. In this way, since the stop portion 122 is limited by the support portion 16, the positioning columns 121 connected to the stop portion 122 are unable to separate from the positioning holes 16a, and the interactive shell 12 is unable to be detached from the support portion 16. Therefore, the stability of the interactive shell 13a on the support portion 16 is improved.

As shown in FIGS. 19-20, in some embodiments, an annular protrusion 123 is disposed on one of an inner side edge of the interactive shell 13a and an edge of the support portion 16, an annular groove 16b is defined on the other one of the inner side edge of the interactive shell 13a and the edge of the support portion 16, and the annular protrusion 123 is snapped into the annular groove 16b. For example, as shown in FIG. 19, the annular protrusion 123 is disposed on the inner side edge of the interactive shell 13a, and the annular groove 16b is defined on the edge of the support portion 16. Alternatively, the annular groove 16b is defined on the inner side edge of the interactive shell 13a, and the annular protrusion 123 is disposed on the edge of the support portion 16. In this way, a contact area between an edge of the interactive shell 13a and the support portion 16 is increased, connection stability between the edge of the interactive shell 13a and the support portion 16 is improved, the edge of the interactive shell 13a is prevented from tilting relative to the main shell 11a, and the stability of the interactive shell 13a on the main shell 11a is improved.

As shown in FIG. 16, in some embodiments, an outer surface 1313 of the interactive shell 13a and an outer surface of the main shell 11a are smoothly transited. In this way, the handle housing 10a does not rub the hand. Further, since there is no step structure between the interactive shell 13a and the main shell 11a, the user's sight of observing the viewing shell 131a of the interactive shell 13 is not blocked. Further, there is no gap between the outer surface 1313 of the interactive shell 13a and the outer surface of the main shell 11a, so there is no gap for hiding dirt or harboring bacteria.

In some embodiments, a thickness of the interactive shell 13a is not less than 0.2 mm, so that the interactive shell 13a has sufficient thickness to buffer the impact force. If the thickness of the interactive shell 13a is less than 0.2 mm, the thickness of the interactive shell 13a is too thin, and when subjected to a large impact force, a probability of the interactive shell 13a being directly damaged is greatly increased.

As shown in FIG. 17, in some embodiments, along a circumference of the handle housing 10a, a middle portion of the interactive shell 13a is higher than two ends of the interactive shell 13a. Therefore, a middle portion of the viewing shell 131a is also higher than two ends of the viewing shell 131a along the circumference of the handle housing 10a. The middle portion of the viewing shell 131a serves as a main display area and is more easily observed by the user without being blocked by the two ends of the viewing shell 131a along the circumference of the handle housing 10a. As shown in FIG. 17, in some embodiments, the interactive shell 13a further includes a button 14 integrally formed with the viewing shell 131a. In the embodiment, the button 14 and the viewing shell 131a are close to each other and are located in an upper half portion of the main shell 11a, so that the button 14 and the viewing shell 131a are enabled to be integrally formed.

Considering defects of the related art proposed in the background, that is, in the related art, in order to prevent a light-transmitting shell from being scratched and affecting the display effect, the light-transmitting shell is generally made from a light-transmitting material with high hardness, such as high-hardness light-transmitting glass or high-hardness light-transmitting plastic. Therefore, soft rubber materials are not commonly used to manufacture the light-transmitting shell. Considering effectiveness when pressing the button and shortening a pressing stroke of the button, the button in the related art is usually made of hard materials such as hard plastic or metal. However, the present disclosure overcomes the technical limitations and makes the viewing shell 131a and the button 14 thereof both made from soft rubber. Therefore, the viewing shell 131a and the button 14 are allowed to be integrally formed. In this way, the button 14 is formed at the same time as the viewing shell 131a is formed, and no additional process is required to manufacture the button 14, which simplifies the manufacturing process and saves manufacturing cost of the button 14. Moreover, the button 14 is made from soft rubber, so the button is not easy to be damaged or detached from the main shell 11 when subjected to force. In some embodiments, an integral piece consisting of the button 14 and the viewing shell 131a is formed on the main shell 11a by injection molding. That is, the main shell 11a is first molded, and then the viewing shell 131a and the button 14 are molded on the main shell 11a by injection molding. Specifically, the main shell 11a is first molded by injection molding, and then the interactive shell 13a (that is, the button 14 and the viewing shell 131a) can be molded on the main shell 11a by secondary injection molding, two-color injection molding, or lamination. In this way, not only can the connection stability between the interactive shell 13a and the main shell 11a be increased, but also the production process is simplified and the manufacturing cost is reduced.

As shown in FIG. 19, in some embodiments, the button 14 includes an annular ridge 141 protruding from the outer surface of the viewing shell 131a for touching and positioning. In this way, the user is able to determine a position of the button 14 by touching without observing the button 14, thereby improving the simplicity and ease of operation of the button 14.

As shown in FIG. 19, in some embodiments, the handle housing 10a includes a top end 101 close to the brush head 20a of the electric toothbrush 100a and a bottom end 102 away from the top end 101. Specifically, the top end 101 of the handle housing 10a is an end of the handle housing 10a closer to the brush head 20a, and the bottom end 102 of the handle housing 10a is an end of the handle housing 10a away from the brush head 20a. The interactive shell 13a is closer to the top end 101 of the handle housing 10a than the bottom end 102 of the handle housing 10a, so that when the user holds the main shell 11a, the thumb properly press the button 14 for operation. The viewing shell 131a is disposed between the button 14 and the top end 101 of the handle housing 10a, so that when the thumb presses the button 14, the viewing shell 131a is not blocked, which is convenient for the user to observe the viewing shell 131a.

In the drawings of the embodiments, the same or similar numbers correspond to the same or similar components; in the description of the present disclosure, it should be understood that terms such as “upper”, “lower”, “left”, “right”, etc. indicate direction or position relationships shown based on the drawings, and are only intended to facilitate the description of the present disclosure and the simplification of the description rather than to indicate or imply that the indicated device or element must have a specific direction or constructed and operated in a specific direction. Therefore, the terms used to describe positional relationships in the drawings are only for illustrative purposes and cannot be construed as limitations of the present disclosure. For those of ordinary skill in the art, the specific meanings of the above terms can be understood according to specific circumstances.

The above are only optional embodiments of the present disclosure and are not intended to limit the present disclosure. Any modifications, equivalent substitutions, and improvements made within the spirit and principles of the present disclosure shall be included in the protection scope of the present disclosure.

What is claimed is:

1. An electric toothbrush, comprising:
a handle housing, and
a driving component;
wherein the handle housing comprises a main shell and an interactive shell; the main shell and the interactive shell are connected to each other; the interactive shell comprises a viewing shell and a button portion;
wherein the driving component is disposed in the handle housing; the driving component comprises a detection piece and a display light source; the detection piece is disposed corresponding to the button portion to detect whether the button portion is pressed or touched; the display light source is disposed corresponding to the viewing shell; the display light source is configured to transmit light to an outside of the handle housing through the viewing shell.

2. The electric toothbrush according to claim 1, wherein the interactive shell is integrally formed, and the interactive shell is formed by injection molding of a soft rubber or a hard plastic.

3. The electric toothbrush according to claim 1, wherein the main shell and the interactive shell are integrally formed, and the main shell is gaplessly connected to the interactive shell.

4. The electric toothbrush according to claim 1, wherein the main shell comprises a mounting opening configured to mount the interactive shell, and an outer peripheral wall of the interactive shell is connected to an inner wall of the mounting opening to cover the mounting opening.

5. The electric toothbrush according to claim 4, wherein an outer surface of the button portion defines a pressing area; the pressing area is an arc surface recessed toward the detection piece relative to an outer surface of the viewing shell.

6. The electric toothbrush according to claim 5, wherein in a radial direction of the handle housing toward an interior of the handle housing, a height of an inner surface of the button portion is greater than a height of an inner surface of the viewing shell; the inner surface of the button portion is a flat surface facing the detection piece or an arc surface protruding towards the detection piece.

7. The electric toothbrush according to claim 6, wherein an outer surface of the viewing shell defines a first curvature; the main shell comprises a front surface on a same side as the interactive shell; the front surface of the main shell defines a second curvature; the first curvature is less than the second curvature.

8. The electric toothbrush according to claim 1, wherein an inner surface of the viewing shell comprises an inner light-transmitting area disposed opposite to the display light source; the inner light-transmitting area is an arc surface recessed in a direction away from the display light source relative to an inner surface of the button portion.

9. The electric toothbrush according to claim 1, wherein an outer surface of the button portion defines a pressing area; the pressing area is an arc surface recessed toward the detection piece relative to an outer surface of the viewing shell;
wherein the outer surface of the viewing shell is an arc surface protruding in a direction away from the display light source relative to the pressing area, and an outer surface of the viewing shell is in smooth transition with the pressing area.

10. The electric toothbrush according to claim 1, wherein the main shell comprises a metal shell and a plastic shell; the metal shell defines a mounting opening; the interactive shell is mounted in the mounting opening to cover the mounting opening;
wherein the plastic shell is disposed on an inner wall of the metal shell; the driving component is connected to the plastic shell; the plastic shell defines a through hole communicated with the mounting opening; the button portion is matched with the detection piece through the through hole; light emitted by the display light source passes through the through hole and the viewing shell in sequence to transmit to the outside;
wherein an aperture of the through hole is less than an aperture of the mounting opening to define a support platform on a bottom portion of the through hole; the support platform is annular and is configured to support the interactive shell.

11. The electric toothbrush according to claim 1, wherein a surface of the support platform supporting the interactive shell defines an adhesive filling groove, the adhesive filling groove is n annular, adhesive is disposed in the adhesive filling groove, and the adhesive is bonded with an edge area of an inner surface of the interactive shell.

12. The electric toothbrush according to claim 1, wherein the detection piece comprises a pressure switch; the button portion is configured to compress the pressure switch by deformation to trigger the pressure switch; or
the detection piece comprises a button, and the button portion is configured to abut against the button by deformation to trigger the button; or
a position where the button portion is located is light-transmissive, and the detection piece comprises a light detection piece; the light detection piece is configured to detect a luminous flux at the button portion; or
the detection piece comprises a sound wave detection piece, and the sound wave detection piece is configured to detect a sound wave signal reflected at the button portion; or
the detection piece is a temperature detection piece, and the temperature detection piece is configured to detect a temperature signal at the button portion.

13. The electric toothbrush according to claim 1, wherein the interactive shell is a hard light-transmitting plastic piece, or the interactive shell is made from soft rubber for being elastically deformed relative to the main shell.

14. The electric toothbrush according to claim 13, wherein a light-shielding layer is disposed on a surface of the viewing shell, the viewing shell defines at least one light-emitting area not covered by the light-shielding layer; the at least one light-emitting area is disposed corresponding to the light-transmitting portion.

15. The electric toothbrush according to claim 13, wherein the main shell and the mounting piece are integrally formed; both of the main shell and the mounting piece are non-light-transmitting pieces; the light-transmitting portion defines at least one light-transmitting hole penetrating through the mounting piece; the at least one light-transmitting hole is disposed corresponding to the display light source and the viewing shell; the display light source comprises at least one lamp bead or at least one display screen.

16. The electric toothbrush according to claim 13, wherein the main shell and the mounting piece are split pieces, the main shell is a non-light-transmitting piece, and the mounting piece is a light-transmitting piece; or, the main shell and the mounting piece are integrally formed, the main shell and the mounting piece are light-transmitting pieces, and a light-shielding layer is disposed on a surface of the main shell.

17. The electric toothbrush according to claim 13, wherein the mounting piece defines a mounting groove recessed relative to a surface of the main shell, and the interactive shell is mounted in the mounting groove.

18. The electric toothbrush according to claim 13, wherein the mounting piece comprises a protruding portion; the protruding portion is annular; the protruding portion protrudes relative to a surface of the main shell; the mounting groove is defined in the protruding portion.

19. The electric toothbrush according to claim 13, wherein the mounting piece comprises a support portion configured as a groove bottom of the mounting groove; the support portion supports the interactive shell; the light-transmitting portion comprises at least one light-transmitting hole defined on the support portion; the at least one light-transmitting hole is disposed corresponding to the viewing shell; the at least one light-transmitting hole is disposed corresponding to the display light source of the electric toothbrush.

20. The electric toothbrush according to claim 19, wherein positioning columns are disposed on an inner surface of the interactive shell; positioning holes are defined on the support portion; the positioning columns respectively pass through the positioning holes; the interactive shell further comprises stop portion; the stop portion is connected to ends of the positioning columns passing through the positioning holes; the stop portion and the inner surface of the interactive shell jointly clamp the support portion.
